(19) United States
(12) Patent Application Publication
(10) Pub. No.: US 2022/0228542 A1
(43) Pub. Date: Jul. 21, 2022

(54) PROPULSION ASSEMBLY FOR A ROCKET

(71) Applicant: Centre National d'Études Spatiales CNES, PARIS (FR)

(72) Inventors: Nathalie GIRARD, BALLAINVILLIERS (FR); Emilie LABARTHE, ST GERMAIN LES ARPAJON (FR); Christophe BONNAL, ORSAY (FR); Frédéric MASSON, MONTREUIL (FR)

(73) Assignee: Centre National d'Études Spatiales CNES, PARIS (FR)

(21) Appl. No.: 17/715,416

(22) Filed: Apr. 7, 2022

Related U.S. Application Data
(63) Continuation of application No. PCT/FR2020/051713, filed on Sep. 30, 2020.

(30) Foreign Application Priority Data
Oct. 8, 2019 (FR) 19/11131

(51) Int. Cl. F02K 9/50; F02K 9/46

(52) U.S. Cl. CPC F02K 9/50; F02K 9/46

(57) ABSTRACT

A propulsion assembly for a rocket includes a propellant tank configured to contain a propellant and an engine comprising a combustion chamber configured to subject the propellant to combustion and generate exhaust gases. The propulsion assembly further includes a supply circuit and an exhaust gas circuit. The supply circuit is disposed between the propellant tank and the combustion chamber, and the supply circuit is configured to supply the combustion chamber with the propellant. The exhaust gas circuit is disposed between the combustion chamber and the propellant tank, and the exhaust gas circuit is configured to convey at least part of the exhaust gases from the combustion chamber to the propellant tank to provide pressurization of the propellant tank.

### CROSS-REFERENCE TO RELATED APPLICATIONS

This application is a continuation of International Application No. PCT/FR2020/051713, filed on Sep. 30, 2020, which claims priority to and the benefit of FR 1911131 filed on Oct. 8, 2019. The disclosures of the above applications are incorporated herein by reference.

### FIELD

The present disclosure relates to a propulsion assembly for a rocket comprising a propellant tank as well as a method for pressurizing said tank.

### BACKGROUND

The statements in this section merely provide background information related to the present disclosure and may not constitute prior art.

Generally, exhaust gases generated in a combustion chamber of an engine are evacuated via a nozzle to generate thrust.

Rocket engines supplied with liquid propellant(s) are known in the prior art. The propellants are contained in tanks and are conveyed by supply ducts to the combustion chamber of the engine in which they are mixed. This mixture of propellants produces a combustion whose exhaust gases evacuated by the nozzle at the outlet of the combustion chamber cause the rocket to take off.

To provide a regular flow rate of propellant between the propellant tank and the combustion chamber, it is desired to keep the propellant tank under pressure.

For this purpose, gases stored under high pressure are generally used in auxiliary gas tanks that are injected into the propellant tank to provide the pressurization of the propellant tank(s). These gases may be neutral to avoid a reaction with the propellant contained in the propellant tank to be pressurized.

There are also known tank pressurization devices using the exhaust gases from the combustion chamber to vaporize propellant in a heater. The propellant vaporized in the heater is then injected into the propellant tank to provide pressurization thereof. The exhaust gases are generally discharged outside the engine assembly.

Devices using hot gases derived from an external gas generator then cooled by water to provide the pressurization of the propellant tanks are also known.

A drawback of the solutions of the prior art lies in the need to carry auxiliary tanks to contain the pressurization gases of the propellant tank and/or of the coolant fluids tanks. The architecture of the rocket stages is made more complex and heavier, resulting in increased manufacturing costs and a loss in performance for these launchers.

### SUMMARY

This section provides a general summary of the disclosure and is not a comprehensive disclosure of its full scope or all of its features.

The present disclosure overcomes at least one of these drawbacks and relates, according to a first aspect, to a propulsion assembly for a rocket comprising a propellant tank configured to contain a propellant, an engine comprising a combustion chamber configured to subject the propellant to a combustion and generate exhaust gases, a supply circuit, and an exhaust gas circuit. The supply circuit is disposed between the propellant tank and the combustion chamber and is configured to supply the combustion chamber with the propellant. The exhaust gas circuit is disposed between the combustion chamber and the propellant tank and is configured to convey at least one portion of the exhaust gases from the combustion chamber to the propellant tank to provide pressurization of the propellant tank.

By employing the exhaust gas circuit according to the present disclosure, at least one portion of the exhaust gas generated in the combustion chamber is directly conveyed into the propellant tank for pressurization thereof. Thus, the exhaust gases are recycled into the propellant tank, thereby inhibiting the use of auxiliary gas tanks to store the pressurization gas. The structure of the propulsion assembly may be lighter and less expensive. The architecture of the propulsion assembly may be simplified.

According to other features of the present disclosure, the propulsion assembly of the present disclosure includes one or more of the following optional features considered alone or in all possible combinations.

According to one feature, the exhaust gas circuit comprises at least one channel opening to the outside of the propellant tank.

According to one feature, the exhaust gas circuit comprises an expansion device that is adjacent to the propellant tank and configured to regulate an inlet flow rate of exhaust gases into the propellant tank. The regulation of the flow rate provides for maintaining a constant pressure inside the propellant tank, equal to a predetermined value. The expansion device may for example be a pressurization plate or an expander.

According to one feature, the expansion device is a pressurization plate.

According to one feature, the pressurization plate comprises at least one pressure regulation valve.

According to one feature, the propulsion assembly comprises a device or system for measuring the pressure of the propellant tank. This provides for maintaining the pressure inside the propellant tank such that it is constant and equal to a predetermined value.

In one form, the propulsion assembly comprises a pump arranged at the outlet of the propellant tank. The pump is actuated by a turbine arranged at the outlet of the combustion chamber, and the turbine is configured to drive said pump.

In this form, the propulsion assembly comprises a tap-off type engine and, more particularly, an engine in which exhaust gases are drawn from the combustion chamber to drive the turbine.

In one form, the propulsion assembly comprises a pump arranged at the outlet of the propellant tank and an engine configured to drive said pump.

According to one feature, the exhaust gas circuit comprises a heat exchanger configured to cool the exhaust gases at the outlet of the combustion chamber. This inhibits exhaust gases from entering the propellant tank at unacceptable temperatures.

According to one feature, the propellant is a mono-propellant. As used herein, “mono-propellant” refers to a propellant comprising a single propellant and that has the property of being enough alone to provide the propulsion of the rocket.

The mono-propellant is chosen from the mono-propellants having a combustion that releases an inert gas. In one form, the propellant is a metastable poly-nitrogenated mono-propellant.

As used herein, “metastable” refers to a molecule that has an energy level which does not correspond to the overall minimum. A metastable molecule is a molecule that stores energy corresponding to the energy delta with the global minimum, and this energy is restored during the decomposition of the molecule into stable molecules of lower energies. In the case of polynitrogenated molecules, structures with single and/or double bonds between nitrogen atoms which are of lower energies are desired.

One advantage of using a metastable poly-nitrogenated mono-propellant is that its combustion mainly produces nitrogen and thus inhibits the risks of chemical reaction when the exhaust gases generated enter the propellant tank.

According to another aspect, the present disclosure relates to a method for pressurizing a propellant tank of a propulsion assembly as described above, the method including: supplying a propellant into a combustion chamber from a propellant tank containing the propellant, combusting said propellant in the combustion chamber to generate exhaust gases, and conveying the exhaust gases from the combustion chamber to the propellant tank to maintain a pressure in the propellant tank such that the pressure is equal to a predetermined value.

In one form, the pressurization method according to the present disclosure comprises one or more of the following features, considered separately or in combination:

According to one feature, the supplied propellant is a mono-propellant, and the supplied propellant may be a metastable poly-nitrogenated mono-propellant.

According to one feature, the pressurization method comprises a step of cooling the exhaust gases in a heat exchanger.

According to one feature, a pressurization method comprises regulating a pressure inside the propellant tank, said step comprising: determining a pressure value to be maintained inside the propellant tank prior to the step of supplying the propellant, measuring a pressure inside the propellant tank while supplying the propellant into the combustion chamber, and controlling a position of one or more pressure regulation valves to divert at least one portion of the exhaust gases outside the propellant tank, wherein the one or more pressure regulation valves are closed when the pressure measured inside the propellant tank is lower than the predetermined value, and the one or more pressure regulation valves are opened when the pressure measured inside the propellant tank is higher than the predetermined value.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic illustration of a propulsion assembly for a rocket according to the present disclosure; and

FIG. 2 is a schematic illustration of a propulsion assembly for a rocket according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

For simplicity, identical elements are identified by identical reference signs in all figures.

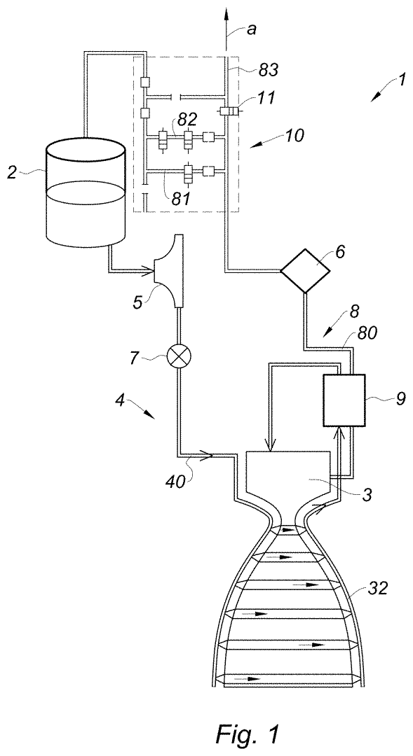

In the example represented in FIG. 1, the propulsion assembly is made on the basis of a Tap-off type engine, that is to say an engine in which exhaust gases are drawn from the combustion chamber to supply energy to certain portions of the engine.

The propulsion assembly 1 comprises a tank 2 and a rocket engine comprising a combustion chamber 3.

The propellant tank 2 is configured to contain a propellant. This propellant is in liquid form in the propellant tank 2. In one form, the propellant is a metastable poly-nitrogenated mono-propellant.

The propulsion assembly 1 comprises a supply circuit 4 disposed between the propellant tank 2 and the combustion chamber 3. The supply circuit 4 connects the propellant tank 2 to the combustion chamber 3. The supply circuit 4 is formed in a conventional manner by a propellant circulation pipe 40. The supply circuit 4 provides for the supply of the combustion chamber 3 with propellant from the propellant tank 2.

The supply circuit 4 comprises a pump. In the present example, the pump is a turbopump 5 arranged at the outlet of the propellant tank 2. The turbopump 5 is configured to pressurize the liquid propellant at the outlet of the propellant tank 2 before injection thereof into the combustion chamber 3. The turbopump is driven by a turbine 6 disposed at the outlet of the combustion chamber 3.

The turbine 6 is actuated by the exhaust gases leaving the combustion chamber 3 and passing through the turbine 6. The operation of the turbine 6 causes the actuation of the turbopump 5.

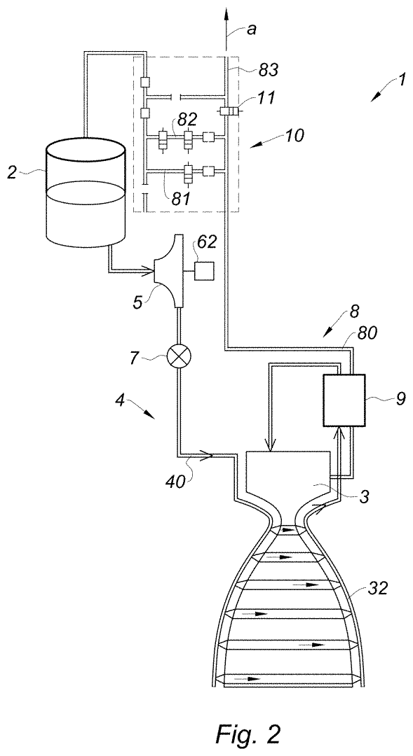

As illustrated in FIG. 2, the propulsion assembly 1 may be deprived of the turbine 6 and comprise an electric motor 62 configured to drive the turbopump 5.

A flow rate regulation valve 7 for regulating the flow rate of propellant is arranged adjacent to the turbopump 5. This flow rate regulation valve 7 allows regulating the flow rate of propellant entering the combustion chamber 3.

The propulsion assembly 1 comprises an exhaust gas circuit 8 arranged at the outlet of the combustion chamber 3. The exhaust gas circuit is disposed between the combustion chamber 3 and the propellant tank 2.

The exhaust gas circuit 8 provides for conveying at least one portion of the exhaust gases from the combustion chamber 3 to the propellant tank 2 to provide pressurization thereof. The exhaust gas circuit 8 is formed in a conventional manner by an exhaust gas circulation pipe 80.

The exhaust gas circuit 8 may comprise a heat exchanger 9. The heat exchanger 9 is configured to cool the exhaust gases leaving the combustion chamber 3. Cooling of the exhaust gases in the heat exchanger 9 is provided by a cold source. The cold source of the heat exchanger 9 is provided by propellant coming from the supply circuit 4, which provides for removing an external cold source branch. In addition, the heat exchanger 9 may be connected to the supply circuit 4.

The exhaust gas circuit 8 may comprise an expansion device 10. In the present example, the expansion device 10 is a pressurization plate. This pressurization plate is arranged between the turbine 6 and the inlet of the propellant tank 2. This pressurization plate is configured to regulate the flow rate of exhaust gas entering the interior of the propellant tank 2.

The inlet flow rate of the exhaust gases is regulated according to the pressure measured inside the propellant tank 2. For this purpose, the pressure measurement system or device refers to pressure sensors (not represented) that may be disposed inside the propellant tank 2. Other equivalent devices or systems deemed compatible by those skilled in the art could be used as pressure measurement device or system. The pressure measurement system or device maintains a constant pressure inside this tank.

The exhaust gas circulation pipe 80 is divided, at the pressurization plate, into a plurality of channels 81, 82, 83 comprising one or several pressurization valve(s) 11. One of the channels 83 opens outside the propellant tank 2 in the direction of the arrow “a”. The channel 83 opening outside the exhaust gas circuit comprises a pressure regulation valve 11. The regulation valve is movable between a closed position to provide for closing the channel 83 and an open position to provide for opening the channel 83 to divert at least one portion of the flow of the exhaust gases outside the tank when it is opened. This provides for regulating the flow rate of exhaust gas entering the propellant tank 2 according to the pressure measured in the propellant tank 2.

The expansion device of the present disclosure is not limited to a pressurization plate and may include, for example, an expander such as a hydraulic expander. The expander provides for removing the pressure sensors in the tanks. The expander is configured to determine the pressure inside the tank in a standalone manner due to a membrane system and is configured to open and close regularly to maintain the pressure inside the tank at a constant value.

In operation, the propellant tank 2 filled with propellant delivers the fuel. The fuel passes through the propellant circulation pipe 40 of the supply circuit 4 from the propellant tank 2 up to the combustion chamber 3.

When the propellant passes through the supply circuit 4, the propellant passes through the turbopump 5. The passage through the turbopump 5 allows compression of the fuel so that the propellant enters the combustion chamber 3 under optimum pressure, speed and temperature conditions.

The propellant then enters the combustion chamber 3 in which it undergoes combustion. The combustion of the propellant generates exhaust gases.

A portion of the exhaust gas leaving the combustion chamber 3 is evacuated through a nozzle 32 so as to generate a thrust causing the propulsion of the engine and that of the vehicle on which it is fixed.

Another portion of the exhaust gas is conveyed to the turbine 6 through the exhaust gas circulation pipe 80 of the exhaust gas circuit 8.

The exhaust gases are cooled beforehand in the heat exchanger 9 disposed between the combustion chamber 3 and the turbine 6.

The passage of the exhaust gases in the turbine 6 provides for the turbine 6 to be put into operation, which in turn causes the activation of the turbopump 5.

At the outlet of the turbine 6, the exhaust gases are conveyed to the tank through the exhaust gas circulation pipe 80 to provide pressurization thereof.

Before entering the tank, the exhaust gases pass through the pressurization plate (as the expansion device 10) comprising the pressure regulation valves 11.

The change in the position of the pressure regulation valves is driven by the pressure value measured inside the propellant tank 2. The pressure inside the tank could vary, for example, during the fuel delivery.

The pressure inside the propellant tank 2 is measured using the pressure measuring system or device located inside the propellant tank 2. The interest being to maintain a constant pressure inside the tank for the duration of fuel delivery.

In the case where the pressure measured inside the propellant tank 2 is higher than a predetermined value, that is to say when the propellant tank 2 is under overpressure, the pressure regulation valve 11 arranged on the channel 83 of the exhaust gas circuit opening outside the tank opens. Thus, at least one portion of the exhaust gases is diverted outside the propellant tank 2. The rate flow of exhaust gas is reduced, and the pressure inside the propellant tank 2 decreases.

In the case where the pressure measured inside the propellant tank 2 is lower than a predetermined value, that is to say when the propellant tank 2 is under-pressure, the pressure regulation valve 11 arranged on the channel 83 of the exhaust gas circuit opening outside the propellant tank 2 closes. The exhaust gases are directed entirely inside the propellant tank 2. The flow rate of exhaust gas is increased, and the pressure inside the propellant tank 2 increases.

As could be understood in light of the foregoing, the propulsion assembly according to the present disclosure provides for using a portion of the exhaust gases to pressurize the propellant tank and thus may provide for a simplified structure of the propulsion assembly.

The present disclosure is not limited to the examples that have just been described and many arrangements could be made to these examples without departing from the scope of the present disclosure. In particular, the different features, forms, variants and forms of the present disclosure could be associated with each other in various combinations insofar as they are not incompatible or exclusive of each other.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A propulsion assembly for a rocket, the propulsion assembly comprising:
a propellant tank configured to contain a propellant;
an engine comprising a combustion chamber configured to subject the propellant to combustion and generate exhaust gases;
a supply circuit disposed between the propellant tank and the combustion chamber, the supply circuit configured to supply the combustion chamber with the propellant; and
an exhaust gas circuit disposed between the combustion chamber and the propellant tank, the exhaust gas circuit configured to convey at least one portion of the exhaust gases from the combustion chamber to the propellant tank to provide pressurization of the propellant tank.

2. The propulsion assembly according to claim 1, wherein the exhaust gas circuit comprises an expansion device that is adjacent to the propellant tank and configured to regulate an inlet flow rate of the exhaust gases in the propellant tank.

3. The propulsion assembly according to claim 2, wherein the expansion device is a pressurization plate.

4. The propulsion assembly according to claim 3, wherein the pressurization plate comprises at least one pressure regulation valve.

5. The propulsion assembly according to claim 3, wherein the propulsion assembly comprises a device for measuring the pressure of the propellant tank.

6. The propulsion assembly according to claim 1, wherein the propulsion assembly comprises a pump arranged at an outlet of the propellant tank and a turbine arranged at the outlet of the combustion chamber, the turbine being configured to drive the pump.

7. The propulsion assembly according to claim 1, wherein the propulsion assembly comprises a pump arranged at an outlet of the propellant tank and the engine, the engine being configured to drive the pump.

8. The propulsion assembly according to claim 1, wherein the exhaust gas circuit comprises a heat exchanger configured to cool the exhaust gases leaving the combustion chamber.

9. A method of pressurizing the propellant tank of the propulsion assembly of claim 1, the method comprising:
supplying the propellant into the combustion chamber from the propellant tank containing the propellant,
combusting the propellant in the combustion chamber to generate exhaust gases, and
conveying the exhaust gases from the combustion chamber to the propellant tank to maintain a pressure in the propellant tank such that the pressure is equal to a predetermined value.

10. The method according to claim 9, wherein the propellant is a mono-propellant.

11. The method according to claim 9, wherein the propellant is a metastable poly-nitrogenated mono-propellant.

12. The method according to claim 9, further comprising cooling the exhaust gases in a heat exchanger.

13. The method according to claim 9, further comprising regulating the pressure inside the propellant tank, wherein regulating the pressure inside the propellant tank further comprises:
determining a pressure value to be maintained inside the propellant tank prior to supplying the propellant into the combustion chamber,
measuring the pressure inside the propellant tank while supplying the propellant into the combustion chamber, and
controlling a position of one or more pressure regulation valves to divert at least one portion of the exhaust gases outside the propellant tank, wherein the one or more pressure regulation valves are closed when the pressure measured inside the propellant tank is lower than the predetermined value, and the one or more pressure regulation valves are opened when the pressure measured inside the propellant tank is higher than the predetermined value.
